(19) United States
(12) Patent Application Publication
(10) Pub. No.: US 2024/0011519 A1
(43) Pub. Date: Jan. 11, 2024

(54) Method for Operating a Monitoring System

(71) Applicant: Robert Bosch GmbH, Stuttgart (DE)

(72) Inventors: Stefano Delfini, Bettlach (CH); Tjalf Pirk, Stuttgart (DE); Joachim Loeblein, Waiblingen (DE); Gerd Scheying, Stuttgart (DE); Wolfgang Pleuger, Zuchwil (CH)

(21) Appl. No.: 18/255,313

(22) PCT Filed: Nov. 8, 2021
(86) PCT No.: PCT/EP2021/080944

§ 371 Date: May 31, 2023

(30) Foreign Application Priority Data
Dec. 17, 2020 (DE) 10 2020 216 190.9

(51) Int. Cl. F16B 31/02

(52) U.S. Cl. CPC F16B 31/02; F16B 2031/022; F16B 2200/95

(57) ABSTRACT

A method for operating a monitoring system of at least one fastening device includes providing an identifier allocated to the at least one fastening device and a fastening property allocated to the at least one fastening device to a computer device of the monitoring system, and maintaining a digital twin of the at least one fastening device using the computer device by linking the identifier and the fastening property. The method further includes monitoring the at least one fastening device by evaluating the digital twin.

The invention relates to a method for operating a monitoring system of a fastening device as well as a corresponding monitoring system.

### PRIOR ART

In DE 10 2019 211 867, a measurement device for a fastening device is disclosed, comprising a sensor unit configured so as to sense at least one fastening variable, further comprising an interface connected to the sensor unit and configured so as to provide the at least one fastening variable to an external reader device.

### DISCLOSURE OF THE INVENTION

The invention relates to a method for operating a monitoring system of at least one fastening device, wherein an identifier allocated to the fastening device and a fastening property allocated to the fastening device are provided to a computer device of the monitoring system. It is proposed that a digital twin of the fastening device be maintained, in particular created and updated, with the aid of the computer device by linking the identifier and the fastening property, wherein the fastening device is monitored, in particular with respect to state information, by evaluating the digital twin.

The method can be realized in the form of software or in a mixture of software and hardware. In particular, the method can represent a computer-implemented method carried out at least in part by the computer device. To carry out the method, the computer device can comprise at least one processor device and further at least one storage device in which the method is stored as a computer program.

The monitoring system of the fastening device is understood to mean a system comprising a fastening device marked with, in particular, a unique identifier, as well as a computer device. The computer device is at least configured so as to maintain a digital twin for the fastening device and to carry out evaluations of the digital twin. It should be noted that the computer device can also generally be divided into two or more computer device constituents, wherein, for example, a first computer device constituent maintains the digital twin while the second computer device constituent carries out the evaluations. In particular, it is conceivable that portions of the digital twin are transferred, in particular temporarily, from the first computer device constituent to the second computer device constituent in order to carry out an evaluation.

The fastening device is a fastening used in construction, for example an anchor, a dowel, a screw, a drill hook, or the like. An anchor here is understood to be, for example, a component or an assembly of components for the pull-resistant connection or anchoring. The fastening device is provided for installation in a fastening environment, for example a wall, a piece of masonry, a ceiling, or the like. The installation is typically accomplished by means of a force-fit and/or form-fit and/or a material-fit anchoring or connection of the fastening device in the fastening environment, for example by gluing into a drill hole made in the fastening environment. Through the installation, the fastening device is transferred into a state of being arranged in the fastening environment. It should be noted that such fastening devices are generally known to the person skilled in the art.

An in particular unique identifier is or can be allocated to the fastening device. An identifier is understood to be a feature for in particular unique identification of the fastening device. In an embodiment, the identifier of each fastening device contained in the monitoring system is unique within the framework of the monitoring system. For example, the identifier can comprise a number or code made of alphanumeric characters. Further embodiments of the indicator are conceivable and are well-known to those skilled in the art. In particular, the identifier can also be applied on the fastening device, for example in the form of a text, a number, a barcode, a QR code, or the like. The identifier is thus accessible to a user of the monitoring system, for example a tradesman, directly by reading or digitally reading.

The fastening device is further allocated to or allocated to at least one fastening property. The fastening property represents a characteristic feature or a characteristic variable or information for the corresponding fastening device (identifiable via the identifier), at least at a defined time during the installation and/or during the arranged state. In particular, the fastening property comprises a technical, in particular physical, chemical, and/or material-related, property of the fastening device or relating to the fastening device. Further, other information is also conceivable that allows an interpretation with respect to a technical, in particular physical, chemical, and/or material-related property of the fastening device or relating to the fastening device (for example, a type of fastening device that induces a statement about a material property). In an embodiment of the method for operating the monitoring system, the fastening property is selected from a list of properties, comprising:
properties relating to the fastening device, for example
   a quality of the fastening device (such as certifications)
   a type of the fastening device
   a maintenance or inspection or servicing interval (in the following, maintenance is used to mean maintenance as well as inspection and servicing) of the fastening device
   a material of the fastening device
   a design or configuration of the fastening device
   a technical specification of the fastening device, e.g. a tensile strength, breaking strength, etc.
properties relating to the fastening environment, for example,
   a material and a nature of the fastening environment
   information relating to an object arranged in the fastening environment by means of the fastening device
properties relating to the installation of the fastening device, for example
   a type and/or ID of a tool that is or was utilized during the installation of the fastening device
   a type and/or ID of a fastening accessory that is or was utilized during the installation of the fastening device
   a force profile and/or torque profile and/or vibration profile that is or was sensed during installation of the fastening device, in particular during the drilling of a hole for installation and/or during fastening (placing) of the fastening device
   a hole depth, a hole diameter, a quality of cleaning of the hole,
   a position and/or pose of the fastening device after installation,
properties relating to a maintenance (or inspection or servicing) of the fastening device, for example
   a time of last maintenance,
   maintenance activities carried out,
properties relating to measured values sensed by the fastening device with the aid of a sensor device, for example
   measured values (raw data by itself) and/or evaluated values
evaluated and/or interpreted properties, for example information regarding a calculated safety,

as well as combinations of the above. For example, a combination of these fastening properties could consist of the sum of those properties mentioned above that are relevant in the case of an installation of a fastening device, for example, in the case of an anchor, properties relating to a fastening device, properties relating to the fastening environment, and properties relating to the installation of the fastening device.

““Installation” means the operation of assembling the fastening device at or in the fastening environment, for example a piece of masonry. In addition to the actual placement (gluing, screwing in, etc.) of the fastening device, the designation “during installation” also comprises in particular preparatory and/or post-processing activities. Such preparatory and/or post-processing activities can include, for example, preparatory mixing of a binder, drilling of a drill hole, or curing of the binder. Thus, the period of time understood as “during installation” comprises substantially all activities that are at the work site (e.g. at the construction site) in direct connection with the installation (placement) of the fastening device.

The identifier allocated to the fastening device and at least one fastening property allocated to the fastening device are provided to the computer device of the monitoring system. “Provided” is understood in particular to mean that the corresponding variables, in the form of data, are transferred or signally transmitted to the computer device. In an embodiment of the method, the corresponding variables can be provided by reading from a file of the computer device. In an alternative or additional embodiment of the method, the variables can be provided with the aid of a signal transmission to the computer device. In an embodiment of the method for operating the monitoring system, the identifier and the fastening property are sensed during installation and subsequently provided to the computer device. In an alternative or additional embodiment, the identifier and the fastening property are sensed during a state of the fastening device when arranged in the fastening environment and subsequently provided to the computer device. It should be noted that the provision can be temporally independent (in particular later) of the sensing of the identifier and the fastening property. In an embodiment of the method for operating the monitoring system, the identifier and the fastening property are repeatedly, in particular continuously, sensed and provided to the computer device. In this way, a close-meshed monitoring of the fastening device (including the fastening environment) can be realized repeatedly up to and including permanently carried out evaluations.

A digital twin is understood as a digital virtual model allocated to the fastening device and including at least the fastening property provided to the computer device. In particular, in addition to the pure data of the fastening property(s), the digital twin further comprises models, assumptions, and/or simulations relating to the fastening device represented. The identifier serves in the digital twin as an indicator of the dataset to which the fastening device carrying the identifier is uniquely allocated. In this way, in the digital twin, the identifier and fastening property of a fastening device (including fastening environment) are linked to one another. The computer device is configured so as to create and update, i.e. maintain and manage, the digital twin allocated to a fastening device.

By evaluating the digital twin by means of the computer device, the fastening device is monitored. “Monitoring” refers to determining state information relating to the fastening device (including the fastening environment), wherein the state information allows a statement regarding the state, for example wear, maintenance need, replacement need, force distribution, or the like. It should be noted that the state information is not necessarily static information, but can also relate to a time-based profile, for example a trend, a development, a forecast, or the like. The determination of the status information by means of evaluation allows, as part of monitoring the fastening device(s), a machine, process, and/or operation efficiency in the installation and/or maintenance of the fastening device(s) to be increased, for example, through an early indication of problems, errors, necessary activities (such as maintenance) and associated targeted plannability of activities in connection with the installation and/or maintenance of the fastening device(s). In an embodiment of the method, the status information derived by the evaluation is defined or selected so as to relate to at least one of the following aspects:
a state, in particular an operating or usage state, of the fastening device, for example a load distribution on the fastening device, a wear level, or a wear
a state of the fastening environment, for example a moisture or temperature of the fastening environment
abnormalities indicative of installation and/or maintenance errors, for example, excessive tensioning of the fastening device in the masonry
abnormalities indicative of a failure of the fastening device and/or the fastening environment, for example, material fractures or cracks in the masonry or combinations of the above.

In an embodiment of the method, it is conceivable to provide that various evaluations are carried out, i.e. various status information is determined. It is thus conceivable that an evaluation to be carried out can be selected by a user of the monitoring system. In this way, a particularly comprehensive and flexibly adaptable method can be specified, with which a user can obtain a particularly good overview of the state of the fastening device (including the fastening environment). Further, it is conceivable that evaluations are carried out, in particular initiated, automatically or semiautomatically, in particular also for different groups of users.

From the prior art, it is previously known to sufficiently secure a fastening device prior to installation with an extensive, time-consuming, and costly certification in order to guarantee a safety requirement. Furthermore, there are often minimum requirements and precise specifications for placement of a fastening device, for example an anchor, the fulfillment of which must be regularly controlled in a costly manner after installation of the fastening device, i.e. in the assembled state of the fastening device. The method according to the invention enables the implementation of a holistic approach for monitoring the fastening device(s), which, in addition to fastening properties of the fastening device, fastening properties of the fastening environment, and fastening properties of the tools used for installation, also takes into account evaluated or interpreted fastening properties (such as time-based changes over a lifecycle of a fastening device) in an evaluation. In particular, a support of the installation and operation (i.e. the use) of the fastening device, including maintenance and inspection, can be expanded with a periodic function monitoring and an early warning function. Thus, a significantly improved safety in operation of the fastening device as well as significantly improved efficiency in installation and operation can be achieved. In detail, the following advantages can be achieved with the method according to the invention:
faster sensing and provision of fastening properties
improved efficiency in the planning, installation, and/or maintenance of fastening devices and/or optimized maintenance cycles
significant acceleration in the monitoring, in particular in evaluating the provided fastening properties including documentation generated automatically
gapless testing of fastening properties, in particular of measured values, rather than high margin of safety and random sampling
improved data evaluation, for example by linking different fastening properties, possibly also different fastening devices, in the digital twin of the monitoring system
deriving specific outputs and instructions for action with target group-oriented preparation, in particular as a function of local regulations and preferences of the respective users
increased safety and calmed state of mind.

In an embodiment of the method for operating the monitoring system, the fastening device is monitored by evaluating the digital twin for a deviation of the fastening property from a target fastening property (for example, a deviation of a determined actual force from a target force) and/or for a fulfillment by the fastening property of a fastening property criterion (for example, reaching a maintenance date).

In an embodiment of the method for operating the monitoring system, the evaluation of the digital twin is carried out with the aid of a machine-learning system, wherein the machine-learning system is configured so as to carry out the evaluation based on the at least one provided fastening property, i.e. in particular, to evaluate state information based on the at least one provided fastening property. In particular, the machine-learning system is understood to mean a technical realization of a self-learning system that learns from specified examples (the so-called training data) and can generalize the learned behaviors after the learning phase has been completed by making patterns and regularities in the training data identified and retrievable. Such machine-learning systems are generally known, for example from DE 10 2005 050 577 A1. It is proposed that, in an embodiment of the method, for determining state information, the machine-learning system comprise an in particular artificial neural network. A machine-learning system, in particular a neural network, such as a Bayesian network, has the advantage that a more reliable and precise determination of state information relating to the fastening device (including the fastening environment) is possible compared to statistical approaches. In particular, even with large amounts of measurement data and different influencing factors on state information, meaningful results can be obtained when determining the corresponding state information. In an embodiment of the method, the neural network is realized as a recurrent neural network or as a folding neural network. It is also conceivable that the machine-learning system carries out a regression, i.e. predicts a progression of state information.

In an embodiment of the method for operating the monitoring system, output information, in particular an instruction for action, is provided as a function of the evaluation, in particular as a function of the status information, to a further computer device. In an embodiment example, the output can be provided to a user of the monitoring system, for example, by means of an output device of the computer device or by means of an output device of a further computer device such as a smart device (smart phone, tablet, smart watch, computer, or the like). In particular, the output information can be provided to a further computer device external to the computer device with the aid of a data communication device. It should be noted that, with the aid of the method according to the invention, in particular in combination with the output of the output information based at least in part on the determined state information, the determined state information relating to the fastening device (including the fastening environment) advantageously becomes accessible to the human perception of the user. The output information refers to information prepared for output by means of an output device, which is in particular user-friendly and based at least in part on the determined status information. In particular, the output information can also correspond to the state information.

In an embodiment of the method for operating the monitoring system, the output information, in particular the instruction for action, relates to:
the state of the fastening device (including fastening environment),
a change in the state, for example a progress or trend, of the fastening device,
a deviation or a trend towards a deviation from a target fastening property of the fastening device, and/or
an abnormality regarding the state of the fastening device.

In an embodiment of the method, an actuator is controlled based at least in part on the evaluation, in particular as a function of the determined state information. To control a physical actuator, for example a maintenance robot, the determined status information is output, in particular transmitted, to a control device of the physical actuator. By means of the control device, a control variable for activating the physical actuator can thus be determined using the status information. A control device serves to control in particular the operation of the physical actuator, for example by the application of regular routines and/or control routines. The control device is provided at least for carrying out further processing based at least in part on the determined state information and to translate the corresponding state information into a control variable for activating the physical actuator in this way. For example, it is conceivable that automatic maintenance of a fastening device can be carried out with the aid of a maintenance robot as a function of the determined state information, wherein the maintenance robot is instructed by the monitoring system to access and maintain the corresponding fastening device with the predetermined identifier. In this way, a particularly efficient method of monitoring can be provided.

The monitoring system in connection with the method for monitoring allows an at least semi-autonomous monitoring system including a method to be functionalized. In particular, this allows a monitoring system to integrate into (or couple to) a “smart building system” or a “building information model,” in which digital twins of entire structures, infrastructure, tools, workpieces up to the digital twin of the fastening device are maintained in a computer device. The fastening properties introduced above, for example in the form of measured values and associated evaluations relating to the fastening devices, represent an advantageous addition to existing approaches. In particular, a powerful analysis model can be provided based on the fastening properties (relating to the fastening device, installation process, fastening environment, . . . ). Beyond simple statistical evaluations, the method allows complex analysis models to be made for a predictive estimation, in particular a temporal extrapolation, of the state of fastening devices.

In a further aspect of the invention, a monitoring system of a fastening device is proposed. The monitoring system comprises a fastening device having an identifier and a computer device (as a so-called “backend”). The computer device is configured so as to maintain a digital twin at least for the fastening device. The monitoring system is configured so as to carry out the method according to the present invention for operating the monitoring system of at least one fastening device. The explanations given in relation to the method also apply with respect to the monitoring system.

In an embodiment of the monitoring system, the fastening device comprises a sensor device, in particular an energy-autonomous one, which is configured so as to sense at least one fastening property in the form of measured values, wherein the fastening device comprises an interface, which is signally connected to the sensor device and configured so as to provide the at least one fastening property to an external reader device, in particular the computer device, wherein the external reader device is configured so as to receive at least the fastening property from the interface of the sensor device.

Such a fastening device, in particular an energy-autonomous one, which is configured so as to sense at least one fastening property in the form of measured values and has an interface that is signally connected to the sensor device and is configured so as to provide the at least one fastening property to an external reader device, is known to a person skilled in the art, for example from DE 10 2019 211 867. The sensor device can comprise one or more sensor elements for sensing the fastening variables. The sensor elements can be configured as passive sensor elements or as active sensor elements. In particular, an active sensor element is understood as a sensor that is configured such that an electrical signal is generated without electrical energy from the outside. For example, the active sensor element can be configured as a thermal element, as a light sensor, as a photovoltaic cell, or as a pressure sensor, in particular as a piezoelectric pressure sensor. For example, the active sensor element can be configured as a piezoelectric or an electrodynamic sensor element. Alternatively or additionally, the active sensor element is configured so as to generate a mechanical or electromagnetic excitation, wherein a response to this excitation can be converted into an electrical signal by the active sensor element. By contrast to the passive sensor element, the active sensor element requires electrical energy from the outside in order to generate the excitation. For example, the active sensor element can be embodied as a piezoelectric layer, a sound generator, a vibration element, or even an electronic oscillating circuit. A passive sensor is in particular understood as a sensor whose parameters are changed by the measured variable. Preferably, the passive sensor is configured such that the parameter can be changed by the measured variable independently of an applied voltage or power supply. The conversion into an electrical signal is preferably carried out as soon as electrical energy is available. In particular, an electronics can convert this parameter into an electrical signal. For example, the passive sensor can be configured as an inductive, capacitive, resistive, and optical sensor element, or as a sensor for pressure, force, inertia, light, humidity, temperature, or magnetic field, as a thermal element, or as a microphone. For example, the electronics can comprise an ASIC, an IC, or integrated circuit, or a microprocessor. Furthermore, the sensor device or electronics can comprise a memory unit. In the memory unit, the fastening variable can be stored at least temporarily. Furthermore, identification information can be stored digitally in the memory unit, via which information the fastening device is identifiable. For example, the identification information can include a type, model, manufacturer information, and/or a unique identification.

The fastening property in the form of measured values is in particular physical variables via which the state of fastening of the fastening device, the state of the fastening device, and/or the state of the fastening environment (i.e. the material in which the fastening device is attached) can be characterized. For example, the fastening property can be configured as a force with which the fastening device is attached, for example, in the case of an anchor, the compressive force on a nut. Alternatively or additionally, the fastening property can also be configured as a position and/or orientation of the fastening device. It is also conceivable that the fastening property is configured as information regarding the moisture and/or corrosion and/or temperature in the area of the fastening device.

The interface can be configured as a wireless interface or as a contact interface. In particular, a wireless interface is understood to be an interface via which the fastening property is wirelessly transferable in the form of the measured values and/or the identifier of the fastening device. The interface can be realized as a Bluetooth, LoRaWAN, WLAN, ZigBee, NFC, Wibree, or WiMAX interface, for example. In the state when connected to the wireless communication unit, the interface is configured as a wireless interface. In particular, a contact interface is understood to mean an interface via which data is exchangeable via direct contact with the external reader device. The interface, in particular the contact interface, preferably comprises a contact element configured so as to transmit data with the aid of an electrical conductor or a light vibration conductor. The wireless communication unit is preferably configured so as to be connectable to the contact element of the interface. Advantageously, via the connection of the wireless communication unit to the interface, an interface configured as a contact interface can be converted into a wireless interface. For example, the wireless communication unit can be configured as an RFID tag or a SAW tag.

The external reader device also has an interface for communication, via which a signal provided by the interface of the fastening device can be received. For example, the interface can be configured as a Bluetooth, LoRaWAN, Wi-Fi, ZigBee, NFC, Wibree, or WiMAX interface. For example, the external reader device can be configured as a battery-operated external reader device. In an embodiment of the monitoring system, the external reader device is realized as a tool, in particular a machine tool, for preparing and/or carrying out the installation of the fastening device and/or carrying out maintenance (or inspection or servicing) of the fastening device. The reader device, in particular the tool, is configured so as to communicate with the interface of the fastening device in order to transfer a fastening property, for example in the form of measured values, and/or the identifier of the fastening device. This data can then be transmitted from the reader device, in particular the tool, to the computer device of the monitoring system. Further, the reader device, in particular the tool, can provide corresponding feedback to the user operating the reader device. The machine tool can be configured, for example, as a drilling machine, as an impact drilling machine, as a hammer, as a screwdriver, as an impact wrench, or the like. It is also conceivable that the external reader device can be configured as a unit specifically intended for reading the fastening device or the interface. It is also conceivable that the external reader device can be configured as a smart device. Alternatively or additionally, it is also conceivable that the external reader device is configured as an autonomous device that autonomously activates and reads the measuring device, for example a robot or a drone. Alternatively or additionally, it is conceivable that the external reader device is configured as a stationary unit (for example a WLAN router) installed in the transmitting range of at least one fastening device, preferably in a transmitting range of multiple fastening devices. Advantageously, multiple fastening devices can be read periodically by means of the interface via the external reader device configured as a stationary unit.

For example, some possible user groups of the monitoring system are mentioned below:
installers that interact with the fastening devices, the tools, and the computer device via utilized tools and/or computer devices, such as smartphones,
facility managers (for example, property owners or administrators) and users of a building who can retrieve output as desired via the computer device regarding state, progress, and abnormalities and/or make inputs; furthermore, alarm functions to this user group are conceivable,
inspectors who can efficiently plan and prepare maintenance via the computer device, for example by quickly identifying critical fastening devices demonstrating abnormalities via the computer device.

Furthermore, it is conceivable to expand the monitoring system with retrofit solutions in the form of independent measuring devices (i.e. sensor devices without specific reference to a fastening device), wherein the measuring devices can be arranged in a targeted manner at critical areas and/or areas to be monitored. Such independent measuring devices are integrated into the monitoring system like fastening devices with sensor devices and also have an identifier, in particular a unique one.

### DRAWINGS

The invention is explained in further detail in the following description with reference to embodiment examples shown in the drawings. The drawings, the description, and the claims contain numerous features in combination. The person skilled in the art will expediently also consider the features individually and combine them into meaningful further combinations. In the figures, identical reference numbers denote functionally identical elements.

The figures show:

FIG. 1 a schematic view of the monitoring system according to the invention;

FIG. 2 a schematic illustration of an embodiment of the method for operating a monitoring system of a fastening device;

FIG. 3 a schematic illustration of an alternative or additional embodiment of the method for operating a monitoring system of a fastening device;

FIG. 4 a schematic illustration of an alternative or additional embodiment of the method for operating a monitoring system of a fastening device;

FIG. 5 a schematic illustration of an alternative or additional embodiment of the method for operating a monitoring system of a fastening device.

### DESCRIPTION OF THE EMBODIMENT EXAMPLES

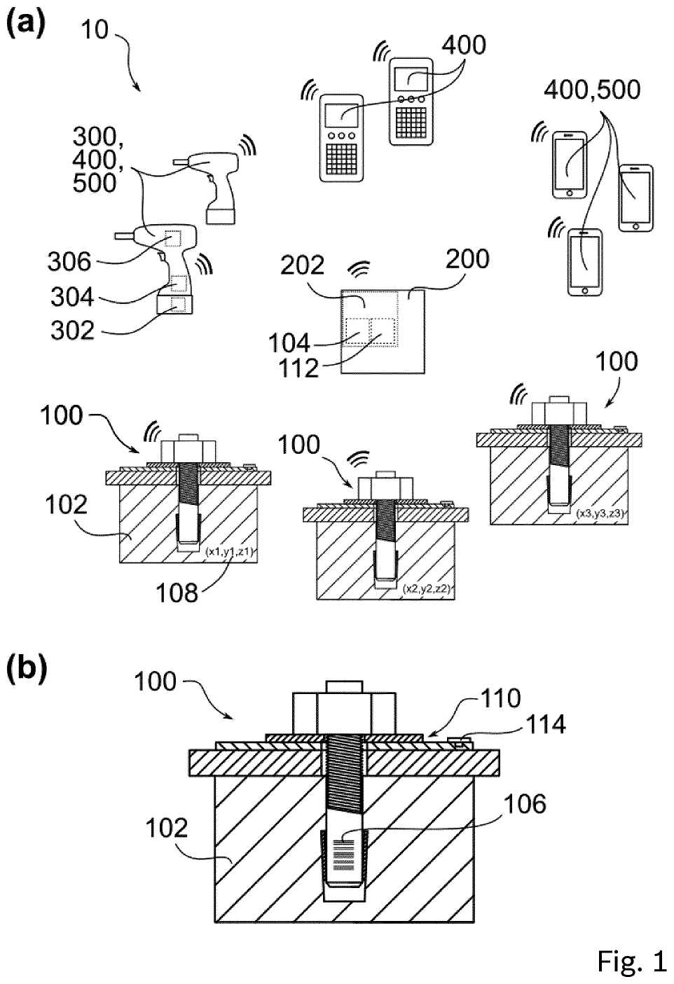

FIG. 1 shows an embodiment example of a monitoring system 10 according to the invention. The monitoring system 10 comprises a plurality of fastening devices 100, shown here as anchors for pull-resistant anchoring in a piece of masonry as the fastening environment 102. The installation of these fastening devices 100 is accomplished by a force-fit and form-fit anchoring in the fastening environment 102 by arranging and screwing the fastening devices 100 into a respective drill hole introduced in the fastening environment 102 (not shown in further detail here). Each fastening device 100 comprises a unique identifier 104 that is realized here as a number encoding. Each identifier 104 is represented in the form of a barcode 106 on a respective fastening device 100.

The monitoring system 10 further comprises a computer device 200, which is configured so as to maintain a digital twin 202 for each of fastening devices 100. Such a digital twin 202 of a fastening device 100 is created by virtually linking the identifier 104 and at least one fastening property 112 to the fastening device 100. A fastening property 112 characterizes the respective fastening device 100 and its installation in the fastening environment 102. In this embodiment example, the following fastening properties 112 can be allocated to a respective fastening device 100 in principle, and can also be determined in the context of the monitoring system:
properties relating to the fastening device 100, specifically a certification, a type, a maintenance interval, and a technical specification (such as tensile strength, breaking strength) of the fastening device 100;
properties relating to the fastening environment 102, specifically a material and a nature of the fastening environment 102;
properties relating to the installation of the fastening device 100, specifically a type and ID of a tool 300 that is or was utilized during installation of the fastening device 100, a force profile that is or was sensed during screwing of the fastening device 100, as well as a position 108 (e.g. as GPS coordinates or as relative position data concerning a reference position (for example, at the entrance of the building); represented here by a (x,y,z) triplet) of the fastening device 100 after the installation;
properties relating to the maintenance of the fastening device 100, specifically the timing and activities of a final maintenance;
as well as
properties sensed by the fastening device 100 by means of a sensor device 110, specifically measured values sensed by the sensor device 110, and properties evaluated and interpreted therefrom.

The sensor device 110 of each fastening device 100 is thus realized in an energy-autonomous manner by having a in particular long-lasting battery. During its operation, the sensor device 110 senses a fastening property 112 in the form of measured values, for example at an interval of one day at a time. The sensor device 110 comprises a sensor element (not shown in further detail here, however cf. DE 10 2019 211 867) in the form of a piezoelectric pressure sensor (realized as a washer here) that determines a pressure acting on the fastening device 100 during its state when arranged in the fastening environment 102. The fastening device 100 further comprises an interface 114 that is signally connected to the sensor device 110 and configured so as to provide the fastening property 112 to an external reader device 400, here either a tool 300 used in the installation or a further computer device 500, such as a smart device 500a.

Data regarding certification, type, maintenance interval, technical specification, and properties relating to the fastening environment 102 can be provided to the computer device 200, for example by a tradesman who carries out the installation of the fastening device 100 in particular via a further computer device 500, such as a smart device 500a. Alternatively or additionally, such data can also be sensed or read by measurement technology (for example, via the barcode 106 on the fastening device 100) and provided to computer device 200.

Data regarding the installation of the fastening device 100 (such as type and ID of a tool 300 used in the installation) or maintenance (time and activity of the last maintenance) can be provided to the computer device 200 manually by the tradesman who carries out the installation or maintenance the fastening device 100, or also automatically, for example via a communication interface 302 of the tool 300 that is or can be connected to the computer device 200.

In particular, the tool 300 can also function as an external reader device 400 or can integrate this function.

The components of the monitoring system 10, i.e. the fastening device 100, the reader device 400, the tool 300, and the further computer device 500, are each configured so as to be signally connected to the computer device 200 for data communication (providing data and/or retrieving data) as represented by the radio icon on each component. For this purpose, the respective device comprises at least one interface for communication.

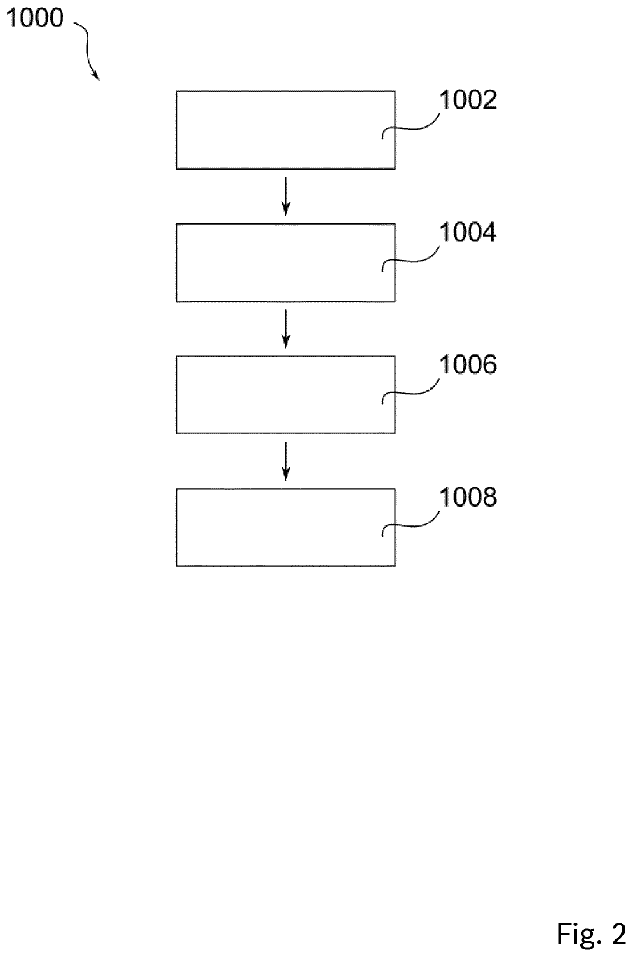

The monitoring system 10 shown in FIG. 1 is configured so as to carry out the method 1000 according to the invention for operating a monitoring system 10 of at least one fastening device 100. The method 1000 is shown in FIG. 2 in the form of a process diagram. In the method step 1002, an identifier 104 allocated to the fastening device 100 and a fastening property 112 allocated to the fastening device 100 are provided to the computer device 200 of the monitoring system 10. By means of the computer device 200, in the method step 1004, by linking the identifier 104 and the fastening property 112, a digital twin 202 of the fastening device 100 is created and/or updated, i.e. maintained and managed, in the computer device 200. In the method step 1006, by evaluating the digital twin 202, the fastening device 100 is monitored. Here, the computer device 200 comprises a machine-learning system (not shown in further detail) by means of which the evaluation of the digital twin 202 is carried out, wherein the machine-learning system is configured so as to carry out the evaluation based on the provided fastening properties 112. For example, the fastening device 100 is monitored for a deviation of the fastening property 112 from a target fastening properties and for fulfillment by the fastening property 112 of a fastening property criterion by evaluating the digital twin 202. In the method step 1008, as a function of the evaluation, an output information, in particular in the form of an instruction for action, is determined by the computer device 200 and provided to a further computer device 500, for example here a smart device or a tool 300, and thus output to a user of the monitoring system 100. The output information, in particular the instruction for action, relates to a state, a change in a state, and/or abnormalities regarding the state of the fastening device 100.

Proceeding from this method 1000, various application scenarios, i.e. configurations or extensions of method 1000, are conceivable.

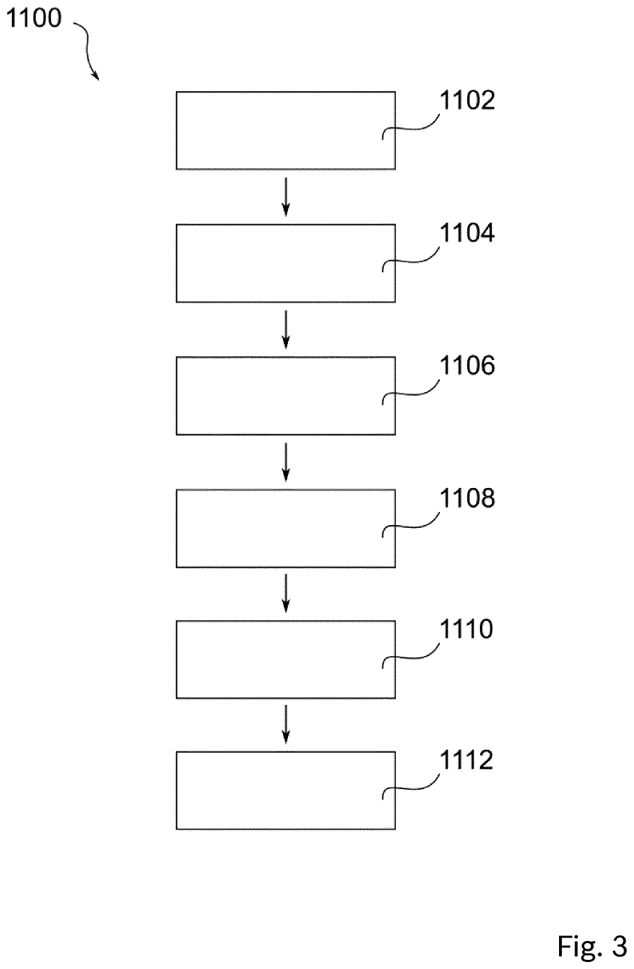

In FIG. 3, the alternative or additional application scenario 1100 “installation support” is shown. In the method step 1102, fastening properties 112 relating to the fastening device 100 are first read from a fastening device 100 to be installed, such as certification, type, biasing force, and maintenance interval. The reading is done by scanning the barcode 106 applied on the fastening device 100 with the aid of a tool 300 provided for installation or a reader device 400 or with the aid of a further computer device 500. Furthermore, via a smart device of the installer (as a further computer device 500), properties relating to the fastening environment 102, such as the material of the fastening environment 102, are input. In the method step 1104, properties relating to the installation of the fastening device 100, such as the type and ID of the tool 300, a position of the tool 300 (with the aid of a position sensing device 304, as is known in the prior art), electrical power, and torque are sensed by the tool 300. In the method step 1106, operating parameters such as the torque of the tool 300 are automatically adjusted according to the specification for the fastening device 100. Then, in the method step 1108, the aforementioned data concerning the fastening properties 112 relating to the fastening device 100, relating to the fastening environment 102, and relating to the tool 300 of the computer device 200 are provided. The latter data also comprise, in particular, a force profile and/or torque profile acquired during screwing of the fastening device 100 by means of a measuring device 306 of the tool, as well as the position 108 of the fastening device 100 obtained by adopting the position of the installation tool 300. As a result, the identifier 104 and the fastening property 112 are sensed during installation of the fastening device 100 (including preparation and post-processing of the pure operation of placing the fastening device 100). The identifier 104 of the fastening device 100 is also provided to the computer device 200. The data are stored in a digital twin 202 allocated to the fastening device 100 with the aid of the identifier 104. It is conceivable that data from multiple fastening devices 100 are merged and stored. Then, in the method step 1110, by evaluating the digital twin 202, the fastening device 100 is monitored. A summarizing evaluation of the installation is generated, which is determined as documentation of the installation process in the method step 1112 in the form of output information by the computer device 200 and provided to a further computer device 500, here in the form of a smart device, and thus output to a user of monitoring system 100.

Alternatively, it is conceivable that the application scenario “installation support” is modified such that the method step 1106 is not part of the method. In particular, this application scenario is then primarily used for efficient documentation.

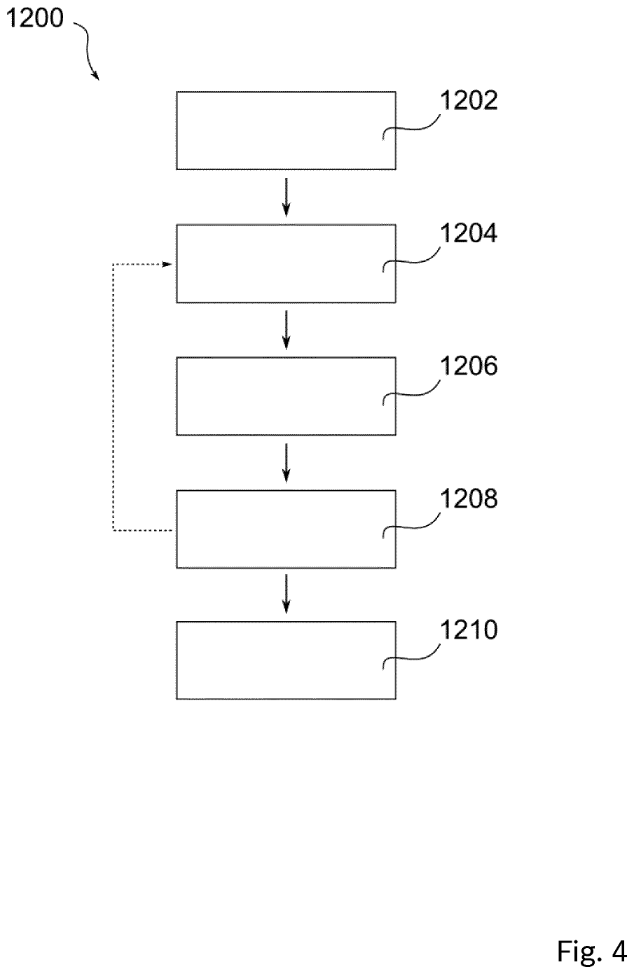

In FIG. 4, the alternative or additional application scenario “state monitoring” is illustrated, which proceeds from an existing digital twin 202, for example created according to method steps 1002, 1004, of the method 1000, shown here by block 1202. Then, in the method step 1204, fastening properties 112 of a fastening device 100 are sensed along with their identifier 104 and provided to the computer device 200. Thus, the identifier 104 and the fastening property 112 are sensed during a state of the fastening device 100 when arranged in the fastening environment 102. This sensing can be provided, for example, by an automated provision, in particular by means of the sensor device 110 of the fastening device 100 and/or by a user of the monitoring system 10, in particular a tradesman tasked with the installation or the maintenance. Further, it is conceivable that further sensors can also be used, which, for example, provide fastening properties 112 relating to the fastening environment 102. The data is updated in the already existing digital twin 202 allocated to the fastening device 100 with the aid of the identifier 104. The method steps 1202 and 1204 are repeated, in particular continuously (see below). As a result, a regularly updated status is known relating to the fastening device 100 as well as the surrounding fastening environment 102 in the monitoring system 10, from which the state, trends, and warnings can then be derived by evaluating the digital twin in the method step 1206. The method step 1206 can also be carried out repeatedly, in particular continuously, such that by repeating or continuously carrying out the method steps 1204, 1206, 1208 (represented by the dashed arrow), a “monitoring” is achieved. In a method step 1208, a summary evaluation can be prepared, in particular in the event of changes relating to the state or other criteria, such as a specific time sequence, determined as documentation of the state of the fastening device 100 (including the fastening environment 102) in the method step 1210 in the form of an output information by the computer device 200, and provided to a further computer device 500, here in the form of a smart device, and thus output to a user of the monitoring system 10. In particular, in the event of changes or abnormalities, for example inconsistencies or exceeded thresholds, it is conceivable to output the output information to the user of the monitoring system 10 in the form of a warning and/or an alarm (for example in the form of a so-called “push message”). The entire method 1200 can also be run repeatedly.

Furthermore, it is conceivable that users of monitoring system 10 can selectively read out information relevant to them from the computer device 200. This data retrieval can be carried out at any time, for example with a further computer device 500, in particular a smart device.

According to the application scenario, this results in improved output results for users of the monitoring system 10. In addition to improved, in particular updated, state information as well as forecasts, for example of service life and maintenance need, more specific recommendations for action or options for action can be derived and output. Furthermore, it is conceivable to optimize outputs, in particular instructions for action, with specific rules and/or filters in order to take into account both legal requirements as well as recommendations from chambers of trades or company-internal regulations. This allows the outputs to be tailored individually, depending on the user (installer, security officer, owner, . . . ), for which the corresponding output is created.

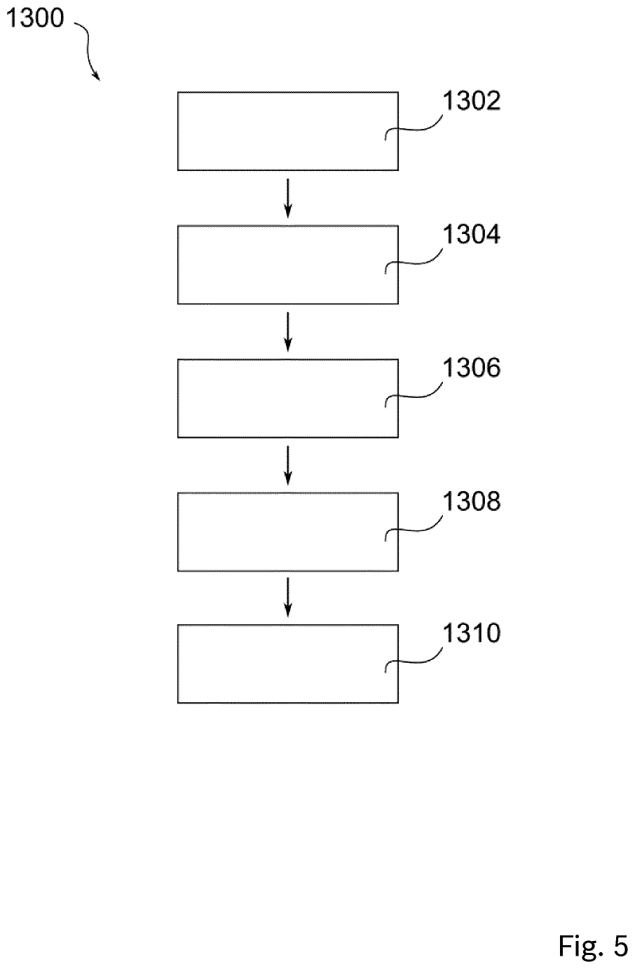

In FIG. 5, the alternative or additional application scenario “maintenance support” is shown. “Maintenance” also refers to inspection and servicing. The method 1300 also proceeds from an existing digital twin 202, for example created according to method steps 1002, 1004 of the method 1000, represented herein by block 1302. As a result, all information required for the prescribed maintenance cycles (such as fastening type, position 108, fastening date, time since fastening date, maintenance cycle period, installation history, previous maintenance protocols, current state, and forecasts) is already available in the digital twin 202 in the computer device 200. As mentioned above, this information is accessible at any time by a user of the monitoring system 10 by means of a further computer device 500, for example by means of a smart device. In the method step 1304, as a result of an evaluation of the digital twin 202, with which (in this example) multiple fastening devices 100 are monitored, it is determined which fastening devices 100 are to be serviced, for example, based on a trend derived from the evaluation, a forecast, and/or by meeting the maintenance-relevant properties (for example, the expiry of a specified time period). The fastening devices 100 to be serviced are then determined in the method step 1306 along with the fastening properties 112, position 108, type of fastening device 100, and tool 300 in the form of output information by the computer device 200 and provided to a further computer device 500, here in the form of a smart device, and thus output to a tradesman tasked with the maintenance. Advantageously, only fastening devices 100 that have been identified to meet certain criteria (for example, expiry of a deadline) and/or particular abnormalities (such as a particular trend) need to be serviced in this manner. The efficiency in the monitoring of the fastening devices 100 can consequently be significantly increased. After carrying out the maintenance, including for example the determination of certain fastening properties 112 and/or tracking of the fastening device 100, the newly determined fastening properties 112 are again provided to the computer device 200 along with abnormalities and the date of the maintenance, indicating the identifier 104 (method step 1308). The data is updated in the method step 1310 in the already existing digital twin 202 allocated to the fastening device 100 with the aid of the identifier 104. As a result, a status of the fastening devices 100 and the surrounding fastening environment 102 in the monitoring system 10 updated after carrying out the maintenance is known, from which the state, trends, and warnings can then continue to be derived, and timely action can be taken.

1. A method for operating a monitoring system of at least one fastening device, comprising:
providing an identifier allocated to the at least one fastening device and a fastening property allocated to the at least one fastening device are provided to a computer device of the monitoring system;
maintaining a digital twin of the at least one fastening device using is maintained with the aid of the computer device by linking the identifier and the fastening property; and
monitoring the at least one fastening device by evaluating the digital twin.

2. The method according to claim 1, wherein the fastening property is selected from a list of properties comprising: at least one of properties relating to the at least one fastening device, properties relating to a fastening environment of the at least one fastening device, properties relating to an installation of the at least one fastening device, properties relating to a maintenance or servicing of the at least one fastening device, properties relating to measured values sensed by a sensor device operably connected to the at least one fastening device, and evaluated and/or interpreted properties.

3. The method according to claim 1, wherein the monitoring the at least one fastening device is monitored includes:
monitoring the at least one fastening device for a deviation of the fastening property from a target fastening property and/or for fulfillment by the fastening property of a fastening property criterion by evaluating the digital twin.

4. The method according to claim 1, wherein a machine-learning system is configured to evaluate the digital twin based on the provided fastening property.

5. The method according to claim 1, further comprising:
generating output information based on the evaluation of the digital twin; and
providing the output information to a further computer device.

6. The method according to claim 5, wherein the output information relates to a state of the at least one fastening device, a change in a state of the at least one fastening device, and/or an abnormality with respect to the state of the at least one fastening device.

7. The method according to claim 1, further comprising:
sensing the identifier and the fastening property during an installation and/or during a state of the at least one fastening device when arranged in a fastening environment.

8. The method according to claim 7, wherein the identifier and the fastening property are repeatedly sensed and provided to the computer device.

9. A monitoring system of a fastening device, comprising:
a fastening device having an identifier; and
a computer device configured so as to maintain a digital twin of the fastening device,
wherein the monitoring system is configured to (i) provide the identifier and a fastening property allocated to the fastening device to the computer device, (ii) maintain the digital twin of the fastening device using the computer device by linking the identifier and the fastening property, and (iii) monitor the fastening device by evaluating the digital twin.

10. The monitoring system according to claim 9, wherein:
the fastening device comprises a sensor device configured to sense the fastening property and to generate corresponding measured values,
the fastening device comprises an interface signally connected to the sensor device and configured so as to provide the fastening property to an external reader device, and
the external reader device is configured to receive the fastening property from the interface of the sensor device.

11. The monitoring system according to claim 10, wherein the external reader device includes a tool configured to prepare and/or to carry out installation of the fastening device and/or to carry out a maintenance or servicing of the fastening device.
